(19) United States
(12) Patent Application Publication
(10) Pub. No.: US 2026/0019558 A1
(43) Pub. Date: Jan. 15, 2026

(54) STEREOSCOPIC DISPLAY DEVICE AND STEREOSCOPIC DISPLAY METHOD

(71) Applicant: JVCKENWOOD Corporation, Kanagawa (JP)

(72) Inventor: Tetsuji SUZUKI, Yokohama-shi (JP)

(21) Appl. No.: 19/336,238

(22) Filed: Sep. 22, 2025

Related U.S. Application Data
(63) Continuation of application No. PCT/JP2024/011339, filed on Mar. 22, 2024.

(30) Foreign Application Priority Data
Mar. 24, 2023 (JP) 2023-048667

(51) Int. Cl. H04N 13/398; H04N 13/322; H04N 13/324; H04N 13/366

(52) U.S. Cl. CPC H04N 13/398; H04N 13/322; H04N 13/324; H04N 13/366

(57) ABSTRACT

A stereoscopic display device includes a laser light source, a converter configured to convert the laser beam to a collimated beam with a predetermined diameter, a scanner configured to three-dimensionally scan a light condensing position of the laser beam by using a drawing space including a fluorescent material which is excited to spontaneously emit light with irradiation with a laser beam as a scan target range and changing a focal distance at which the collimated beam converges and an optical axis direction in which the collimated beam is emitted, a distance detector configured to detect a distance between an observer who observes the drawing space and the drawing space, and a distance correction information acquiring unit configured to acquire distance correction information from a storage unit in which a correlation between the distance and an intensity of the laser beam is stored as the distance correction information.

### TECHNICAL FIELD

The present invention relates to a stereoscopic display device and a stereoscopic display method.

Priority is claimed on Japanese Patent Application No. 2023-048667, filed Mar. 24, 2023, the content of which is incorporated herein by reference.

### BACKGROUND ART

In the related art, various methods for a stereoscopic display device that displays a video in the air have been proposed. For an example of the stereoscopic display device according to the related art, a technique of displaying a video in the air by forming voxels (spatial pixels) by condensing a laser beam to generate plasma has been disclosed (for example, see Patent Document 1).

### CITATION LIST

### Patent Document

Patent Document 1: Japanese Unexamined Patent Application, First Publication No. 2007-206588

### SUMMARY OF INVENTION

The stereoscopic display device can present a clearer stereoscopic image when an image state such as brightness, contrast, or a resolution can be changed according to a situation in which the stereoscopic image is observed. However, in the stereoscopic display device according to the related art, there is a problem in that the states of the stereoscopic image cannot be controlled according to an observation situation.

The present invention was made in consideration of the aforementioned circumstances, and an objective thereof is to provide a stereoscopic display device and a stereoscopic display method that can control a state of a stereoscopic image according to an observation situation.
[1] According to an aspect of the present invention, there is provided a stereoscopic display device including: a laser light source configured to emit a laser beam; a converter configured to convert the emitted laser beam to a collimated beam with a predetermined diameter; a scanner configured to three-dimensionally scan a light condensing position of the laser beam by using a drawing space including a fluorescent material which is excited to spontaneously emit light with irradiation with a laser beam as a scan target range and changing a focal distance at which the collimated beam converges and an optical axis direction in which the collimated beam is emitted; a distance detector configured to detect a distance between an observer who observes the drawing space and the drawing space; a distance correction information acquiring unit configured to acquire distance correction information from a storage unit in which a correlation between the distance and an intensity of the laser beam is stored as the distance correction information; and an intensity control unit configured to control an intensity at the light condensing position of the laser beam with which scanning is performed by the scanner on the basis of drawing data indicating a light emission intensity at each position in the drawing space and the distance correction information corresponding to the detected distance.
[2] In the stereoscopic display device according to the aspect of [1] of the present invention, the intensity control unit sets the number of light emission positions at which the fluorescent material emits light along the optical axis direction to at least three types of different numbers and controls the intensity.
[3] The stereoscopic display device according to the aspect of [1] of the present invention further includes an illuminance detector configured to detect ambient illuminance of the drawing space and an illuminance correction information acquiring unit configured to acquire illuminance correction information from a storage unit in which a correlation between the illuminance and the intensity of the laser beam is stored as the illuminance correction information, and the intensity control unit controls the intensity of the laser beam additionally on the basis of the illuminance correction information corresponding to the detected illuminance.
[4] In the stereoscopic display device according to the aspect of [1] of the present invention, the fluorescent material includes a first area in which a spontaneous light emission intensity changes with respect to a change in intensity of a laser beam that irradiates the fluorescent material and a second area in which the spontaneous light emission intensity changes more loosely than the change of the spontaneous light emission intensity in the first area, and the intensity control unit causes the fluorescent material at a position apart in the optical axis direction from the light condensing position to emit light by setting the intensity of the laser beam at the light condensing position to an intensity at which the fluorescent material at the light condensing position is put in the second area.
[5] The stereoscopic display device according to the aspect of [1] of the present invention further includes a modulator configured to give a periodic distribution to the intensity of the laser beam in the optical axis direction from the light condensing position by changing a spatial frequency distribution of the laser beam, and the intensity control unit sets the number of light emission positions at which the fluorescent material emits light in the optical axis direction and which is caused by the periodic distribution given by the modulator to at least three types of different numbers and controls the intensity.
[6] According to another aspect of the present invention, there is provided a stereoscopic display method including emitting a laser beam, converting the emitted laser beam to a collimated beam with a predetermined diameter, three-dimensionally scanning a light condensing position of the laser beam by using a drawing space including a fluorescent material which is excited to spontaneously emit light with irradiation with a laser beam as a scan target range and changing a focal distance at which the collimated beam converges and an optical axis direction in which the collimated beam is emitted, detecting a distance between an observer who observes the drawing space and the drawing space, acquiring distance correction information from a storage unit in which a correlation between the distance and an intensity of the laser beam is stored as the distance correction information, and controlling an intensity at the light condensing position of the laser beam with which scanning is performed by the scanner on the basis of drawing data indicating a light emission intensity at each position in the drawing space and the distance correction information corresponding to the detected distance.

According to the present invention, it is possible to control a state of a stereoscopic image according to an observation situation.

### BRIEF DESCRIPTION OF DRAWINGS

FIG. 1 A diagram illustrating an example of a configuration of a stereoscopic display device according to an embodiment.

FIG. 2 A diagram illustrating an example of a flow of operations that are performed by the stereoscopic display device according to the embodiment.

FIG. 3 A diagram illustrating an example of light emission intensity characteristics of a fluorescent material according to the embodiment.

FIG. 4A A diagram illustrating an example of a light emission state of a fluorescent material according to the embodiment.

FIG. 4B A diagram illustrating an example of a light emission state of a fluorescent material according to the embodiment.

FIG. 4C A diagram illustrating an example of a light emission state of a fluorescent material according to the embodiment.

FIG. 5 A diagram illustrating an example of scanning with a converged beam according to the embodiment.

FIG. 6 A diagram illustrating another example of scanning with a converged beam according to the embodiment.

FIG. 7 A diagram illustrating an example of distance correction information stored in a storage unit according to the embodiment.

FIG. 8 A diagram illustrating an example of illuminance correction information stored in the storage unit according to the embodiment.

FIG. 9 A diagram illustrating an example of a control table stored in the storage unit according to the embodiment.

FIG. 10 A diagram illustrating an example of a control mode in a control unit according to the embodiment.

### DESCRIPTION OF EMBODIMENTS

Exemplary embodiments of a stereoscopic display device according to an aspect of the present invention will be mentioned and described in detail below with reference to the accompanying drawings. The following embodiments are only examples, and the present invention is not limited to the embodiments. “On the basis of XX” mentioned in this specification means “on the basis of at least XX” and includes “on the basis of another element in addition to XX.” “On the basis of XX” is not limited to direct use of XX and includes use of results obtained by performing calculation or processing on XX. “XX” is an arbitrary factor (for example, arbitrary information). In the drawings used for the following description, scales, numbers, and the like of constituent members may be made to be different from actual scales, numbers, and the like of the constituent members in order to make the constituent members be easily recognized.

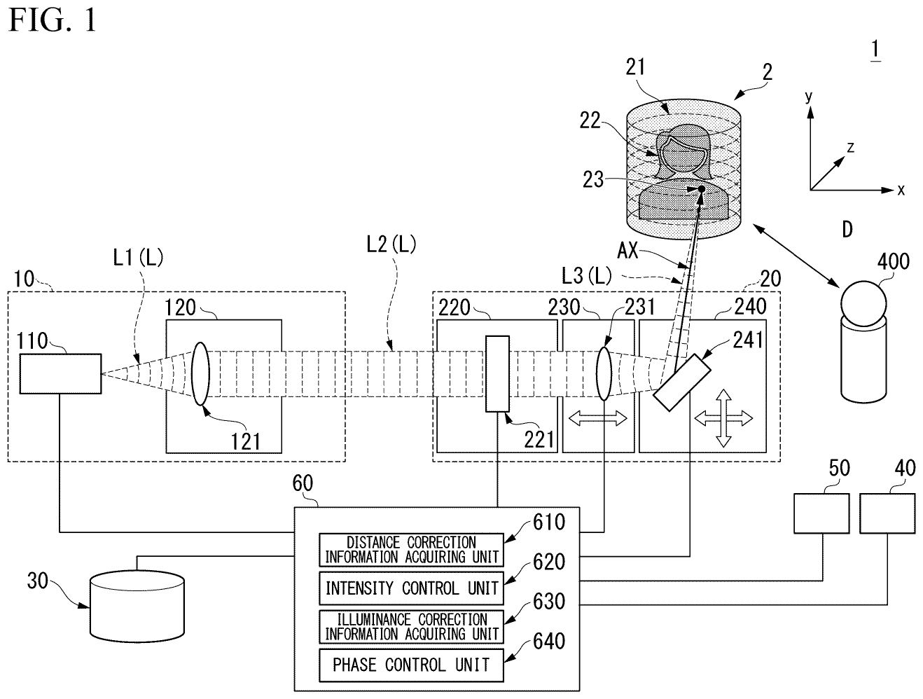

Hereinafter, embodiments will be described with reference to FIGS. 1 to 10.

### [Functional Configuration of Stereoscopic Display Device 1]

FIG. 1 is a diagram illustrating an example of a configuration of a stereoscopic display device 1 according to an embodiment. The stereoscopic display device 1 is a device that displays a stereoscopic image in a drawing space 2 by scanning the drawing space 2 which is a scan target range including a fluorescent material 21 with a laser beam L.

The drawing space 2 is a space in which the fluorescent material 21 can be maintained. For example, the drawing space 2 is an internal space of a cylindrical container with a cylindrical transparent wall in which a powder fluorescent material 21 is enclosed. In this case, the drawing space 2 is a hollow region. For example, the drawing space 2 is an object formed of a transparent resin into which the fluorescent material 21 is kneaded. In this case, the drawing space 2 is a solid region.

That is, “space” of the drawing space 2 has only to be a region which spreads three-dimensionally regardless of whether it is solid or not. The drawing space 2 may be formed of one of gas, liquid, and solid.

The stereoscopic display device 1 includes a light source unit 10, an irradiation unit 20, a storage unit 30, a distance detector 40, an illuminance detector 50, and a control unit 60.

The light source unit 10 includes a laser light source 110 and a converter 120.

The laser light source 110 emits a laser beam L. The laser light source 110 may be, for example, an ultraviolet laser or a small laser diode with a wavelength of 405 nm. In the following description, the laser beam L emitted from the laser light source 110 is also referred to as a source beam L1.

The source beam L1 emitted from the laser light source 110 is not a parallel beam and has characteristics in which the source beam spreads in a conical shape with the laser light source 110 as a vertex.

The source beam L1 immediately after it has been emitted from the laser light source 110 has a sufficiently small diameter. On the other hand, the source beam L1 at a position apart from the laser light source 110 has a larger diameter than that of the source beam L1 immediately after it has been emitted from the laser light source 110. Accordingly, the source beam L1 immediately after it has been emitted from the laser light source 110 has higher energy per unit area in the diameter direction. The source beam L1 at a position apart from the laser light source 110 has lower energy per unit area in the diameter direction.

The converter 120 includes a collimating lens 121. The collimating lens 121 converts the source beam L1 spreading and propagating in a conical shape to a parallel beam with a predetermined diameter. In the following description, the laser beam L converted to a parallel beam by the collimating lens 121 is also referred to as a collimated beam L2. That is, the converter 120 converts the emitted source beam L1 to a collimated beam L2 with a predetermined diameter.

The collimated beam L2 is a beam obtained by converting a source beam L1 with lower energy per unit area in the diameter direction to a parallel beam as described above. Accordingly, the collimated beam L2 has lower energy per unit area in the diameter direction.

The irradiation unit 20 causes the collimated beam L2 incident from the light source unit 10 to converge and guides the converged collimated beam L2 to a light condensing position 23 in the drawing space 2. In the following description, the collimated beam L2 caused to converge by the irradiation unit 20 is also referred to as a converged beam L3. A propagating direction of the converged beam L3 emitted from the irradiation unit 20 is also referred to as an optical axis Ax.

As described above, the converged beam L3 is a beam obtained by causing the collimated beam L2 to converge (that is, to decrease in diameter). Accordingly, the converged beam L3 is higher in energy per unit area in the diameter direction than the collimated beam L2. The energy per unit area in the diameter direction of the converged beam L3 is the highest at a most converged (diameter-decreased) position.

That is, the energy of the converged beam L3 incident on the fluorescent material 21 is the highest at the most converged (diameter-decreased) position.

The irradiation unit 20 includes a modulator 220, a converger 230, and a scanner 240.

The modulator 220 includes, for example, a spatial phase modulator 221 or a two-dimensional diffraction grating 222 and changes a spatial frequency distribution of the collimated beam L2. As a result, a periodic distribution is formed in an intensity of the laser beam L in the direction of the optical axis AX of the converged beam L3 emitted from the irradiation unit 20.

That is, the modulator 220 gives a periodic distribution to the intensity of the converged beam L3 (laser beam L) in the direction of the optical axis AX (the optical axis direction) from the light condensing position 23 by changing the spatial frequency distribution of the collimated beam L2. In FIG. 1, the spatial phase modulator 221 is illustrated as a transmission type, but may be a reflection type. A transmission-type spatial light modulator and a reflection-type spatial light modulator are different in a direction of incident light (reading light) with respect to output light. The transmission-type spatial light modulator emits output light by causing incident light (reading light) to be transmitted by the spatial light modulator, and the reflection-type spatial light modulator emits output light by causing the incident light (reading light) to be reflected by the spatial light modulator.

The converger 230 includes a converging lens 231. The converging lens 231 can change a position on which the transmitted laser beam L converges (that is, a focal distance) under the control of the control unit 60.

The scanner 240 includes a scan mirror 241 (for example, a galvano mirror or a polygon mirror) and changes an irradiation direction of the laser beam L caused to converge by the converger 230.

Here, a direction in which the scanner 240 scans the drawing space 2 will be described using an XYZ three-dimensional orthogonal coordinate system.

The X axis and the Y axis of the three-dimensional orthogonal coordinate system represent angles of view when the drawing space 2 is seen from the irradiation unit 20. The X axis represents a horizontal direction (a left-right direction in FIG. 1) of the drawing space 2. The Y axis represents a vertical direction (an up-down direction in FIG. 1) of the drawing space 2. The scanner 240 can emit a converged beam L3 to an arbitrary position in the XY plane of the drawing space 2 by changing the direction of the scan mirror 241. That is, the scanner 240 can be said to be a two-dimensional scanner that two-dimensionally scans the XY plane with the converged beam L3.

The Z axis of the three-dimensional orthogonal coordinate system represents a depth when the drawing space 2 is seen from the irradiation unit 20. The converger 230 can change the light condensing position 23 of the converged beam L3 in the Z-axis direction by changing a converging position of the converged beam L3 (a focal distance of the converging lens 231). That is, the converger 230 and the scanner 240 can also be said to be a three-dimensional scanner that three-dimensionally scans the XYZ space with the converged beam L3. In the following description, the scanner 240 may mean a three-dimensional scanner including the converger 230 and the scanner 240 which are matched.

That is, the scanner 240 three-dimensionally scans the light condensing position 23 of the laser beam L by using the drawing space 2 including the fluorescent material 21 which is excited to spontaneously emit light with irradiation with a laser beam L1 as a scan target range and changing the focal distance at which the converged beam L3 converges and the direction of the optical axis AX in which the converged beam L3 is emitted.

In the present embodiment, the scanner 240 may include a light intensity adjuster (for example, an iris) for adjusting an emission light intensity of the laser beam L (the collimated beam L2 or the converged beam L3) or a cutoff element (for example, a shutter) for cutting off emission of the laser beam L (none of which are illustrated). The light intensity adjuster or the cutoff element is controlled in synchronization with the converger 230 and the scanner 240, and thus the light condensing position 23 of the converged beam L3 is controlled to be at an arbitrary position in the drawing space 2.

The distance detector 40 has a known range finding function using a time of flight (TOF) sensor or the like and detects a distance D between an observer 400 who observes the drawing space 2 and the drawing space 2. The distance detector 40 may be a camera or the like.

The illuminance detector 50 has a known illuminance detecting function using an illuminance meter or the like and detects ambient illuminance of the drawing space 2. Here, the ambient illuminance of the drawing space 2 is, for example, brightness in a room when the drawing space 2 is placed in the room and is, for example, brightness in an outdoor open space when the drawing space 2 is placed in the outdoor open space.

Here, “illuminance” may be a physical quantity of which the unit is lux [1x] or may be brightness in a broad sense including a physical quantity associated with an intensity of light such as a “luminous flux” or a “luminous intensity.” In the following description, when “illuminance” is mentioned, it includes the simple meaning of “brightness.”

The storage unit 30 has a known storage function, for example, using a semiconductor storage device or a magnetic storage device and stores various types of information used by the control unit 60.

For example, distance correction information 310 is stored in the storage unit 30. The distance correction information 310 is information indicating a correlation between the distance D and the intensity of a converged beam L3 (laser beam L).

The control unit 60 is, for example, a CPU or a computer device and provides a predetermined function on the basis of programs and data stored in the storage unit 30. The control unit 60 includes a distance correction information acquiring unit 610, an intensity control unit 620, an illuminance correction information acquiring unit 630, and a phase control unit 640 as functional units thereof.

The distance correction information acquiring unit 610 acquires the distance correction information 310 from the storage unit 30. That is, the distance correction information acquiring unit 610 acquires the distance correction information 310 from the storage unit 30 in which a correlation between the distance D and the intensity of a laser beam L (for example, a converged beam L3) is stored as the distance correction information 310.

The intensity control unit 620 controls the intensity of the laser beam L emitted from the irradiation unit 20 on the basis of drawing data stored in the storage unit 30. Drawing data is information indicating brightness of an image at each three-dimensional position in the drawing space 2. That is, the drawing data is information for displaying a stereoscopic image 22.

That is, the intensity control unit 620 controls the intensity at the light condensing position 23 of the converged beam L3 (laser beam L) with which scanning is performed by the scanner 240 on the basis of the drawing data indicating a light emission intensity at each position in the drawing space 2 and the distance correction information 310 corresponding to the distance D detected by the distance detector 40.

The intensity control unit 620 according to the present embodiment controls the intensity of a laser beam L on the basis of the distance D between the drawing space 2 and the observer 400 such that a stereoscopic image clear to the observer 400 is formed.

The illuminance correction information acquiring unit 630 acquires illuminance correction information 320 from the storage unit 30. That is, the illuminance correction information acquiring unit 630 acquires the illuminance correction information 320 from the storage unit 30 in which a correlation between illuminance and the intensity of a laser beam L is stored as the illuminance correction information 320.

The intensity control unit 620 controls the intensity of the laser beam L additionally on the basis of the illuminance correction information 320 corresponding to the detected illuminance.

That is, the intensity control unit 620 controls the intensity at the light condensing position 23 of the converged beam L3 (laser beam L) with which scanning is performed by the scanner 240 on the basis of the drawing data indicating a light emission intensity at each position in the drawing space 2 and the illuminance correction information 320 corresponding to the illuminance detected by the illuminance detector 50.

The illuminance detected by the illuminance detector 50 indicates ambient brightness of the drawing space 2. The intensity control unit 620 according to the present embodiment controls the intensity of the laser beam L on the basis of the ambient brightness of the drawing space 2 such that a stereoscopic image clear to the observer 400 is formed.

The phase control unit 640 controls the phase of the converged beam L3 at the light condensing position 23 by controlling a modulation state of a spatial frequency distribution of the collimated beam L2 in the spatial phase modulator 221 or the two-dimensional diffraction grating 222 provided in the modulator 220.

### [Operations of Stereoscopic Display Device 1]

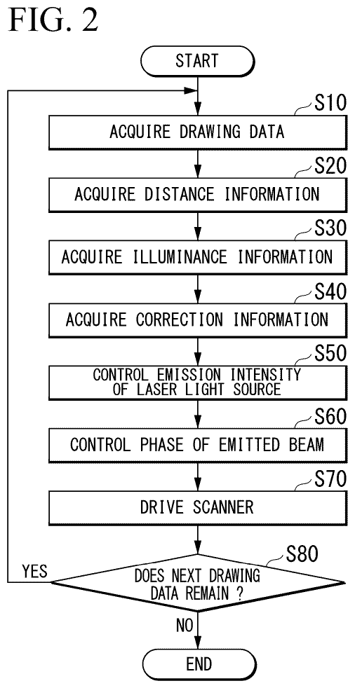

An example of a flow of operations of the stereoscopic display device 1 will be described below with reference to FIG. 2.

FIG. 2 is a diagram illustrating an example of a flow of operations of the stereoscopic display device 1 according to the present embodiment.

(Step S10) The control unit 60 acquires drawing data from the storage unit 30. As described above, the drawing data is information for displaying a stereoscopic image 22.

(Step S20) The control unit 60 acquires distance information from the distance detector 40. As described above, the distance information is information indicating a distance D between the drawing space 2 and the observer 400 which is detected by the distance detector 40.

(Step S30) The control unit 60 acquires illuminance information from the illuminance detector 50. As described above, the illuminance information is information indicating ambient brightness of the drawing space 2 detected by the illuminance detector 50.

(Step S40) The control unit 60 acquires correction information of the intensity of the laser beam L from the storage unit 30. Specifically, the distance correction information acquiring unit 610 acquires the distance correction information 310 from the storage unit 30. The illuminance correction information acquiring unit 630 acquires the illuminance correction information 320 from the storage unit 30.

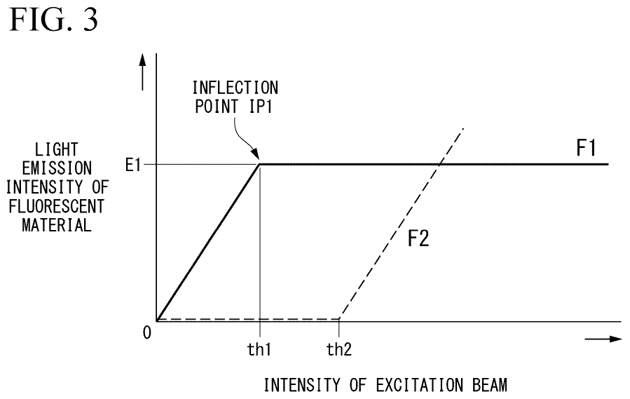

(Step S50) The control unit 60 controls an emission intensity of the laser beam L by controlling the laser light source 110. Here, an example of light emission intensity characteristics of the fluorescent material 21 will be described with reference to FIG. 3.

FIG. 3 is a diagram illustrating an example of light emission intensity characteristics of the fluorescent material 21 according to the present embodiment. In the drawing, light emission intensity characteristics F1 of a first fluorescent material and light emission intensity characteristics F2 of a second fluorescent material are illustrated to overlap each other. The horizontal axis in the drawing represents an intensity of a laser beam L (that is, an excitation beam) incident on the fluorescent material 21, and the vertical axis represents a light intensity emitted from the fluorescent material 21 which has been excited by the excitation beam (that is, a light emission intensity of the fluorescent material 21). The first fluorescent material is, for example, a quantum dot (QD) dispersed material. The QD dispersed material is a material in which quantum dots are dispersed in an organic solvent (for example, toluene), a gas, or a solid at a predetermined volume concentration. The second fluorescent material is, for example, a multiphoton absorber. The second fluorescent material may be a QD dispersed material. Various materials such as CdA, CdSe, CdTe, ZnCdSe/ZnS, and Cd-free perovskite can be used as the quantum dots. Various known fluorescent materials such as YAG, CASN, CSO, and SBCA can be used in addition to the quantum dots.

The first fluorescent material has light emission intensity characteristics in which the light emission intensity of the fluorescent material 21 increases monotonously when the intensity of the excitation beam ranges from 0 (zero) to a threshold value th1 and becomes a light emission intensity E1 at the threshold value th1. Regarding the first fluorescent material, when the intensity of the excitation beam becomes greater than the threshold value th1, the light emission intensity of the fluorescent material 21 does not increase. That is, the first fluorescent material has light emission intensity characteristics F1 in which a changing area (a first area) and a saturated area (a second area) are provided with an inflection point IP1 as a boundary.

That is, in the case of the first fluorescent material, the fluorescent material 21 includes a changing area in which a spontaneous light emission intensity changes with respect to a change in intensity of a laser beam L that irradiates the fluorescent material and a statured area in which the spontaneous light emission intensity does not change. The spontaneous light emission intensity in the saturated area does not change, but the present invention is not limited thereto, and a small change is allowed. That is, the spontaneous light emission intensity in the saturated area has only to change more slowly than the change of the spontaneous light emission intensity in the changing area.

The second fluorescent material has light emission intensity characteristics F2 in which the light emission intensity of the fluorescent material 21 does not increase when the intensity of the excitation beam ranges from 0 (zero) to a threshold value th2 and increases monotonously when the intensity of the excitation beam becomes greater than the threshold value th2. When the second fluorescent material (a multiphoton absorber) is used, an ultrashort pulse infrared laser can be used as the laser light source 110.

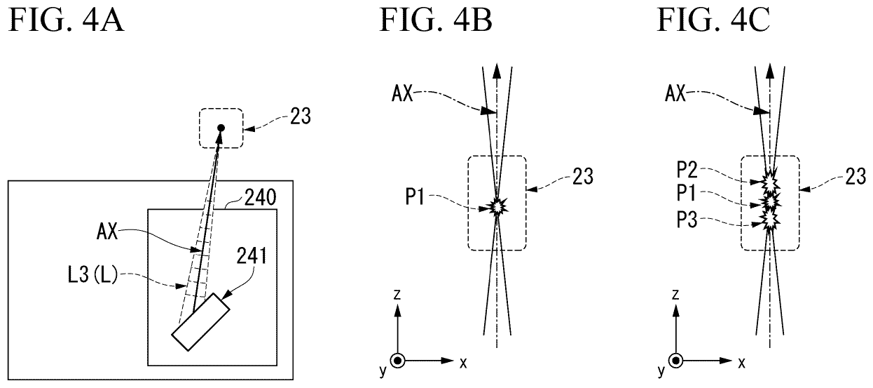

FIG. 4A-4C are a diagram illustrating an example of a light emission state of the fluorescent material 21 according to the present embodiment. FIG. 4A illustrates an example of a light condensing position 23 of a converged beam L3. FIG. 4B illustrates a first example of the light emission state of the fluorescent material 21 at the light condensing position 23. FIG. 4C illustrates a second example of the light emission state of the fluorescent material 21 at the light condensing position 23.

When a laser beam L is emitted as a converged beam L3, the energy per unit volume at the light condensing position 23 is higher than the energy per unit volume in a space other than the light condensing position 23.

The stereoscopic display device 1 according to the present embodiment emits a laser beam L with an intensity at which the fluorescent material 21 does not emit light in a space other than the light condensing position 23 and the fluorescent material 21 emits light at the light condensing position 23. With the stereoscopic display device 1 having this configuration, it is possible to draw a stereoscopic image 22 in the drawing space 2 by performing control such that the fluorescent material 21 at a light condensing position 23 is caused to emit light and the fluorescent material 21 in a space other than the light condensing position 23 is not caused to emit light as illustrated in FIG. 4B. In the example illustrated in FIG. 4B, it is possible to draw a light emitting point P1.

Here, a case in which the fluorescent material 21 has saturation characteristics (light emission intensity characteristics F1) like the first fluorescent material will be described below. When the fluorescent material 21 has the saturation characteristics, the fluorescent material does not emit light more brightly even if a stronger excitation beam than the threshold value th1 is emitted.

On the other hand, when a stronger excitation beam than the threshold value th1 is emitted, a fluorescent material 21 in the vicinity of a saturated fluorescent material 21 (specifically at a position apart in the Z direction on the optical axis AX) out of a plurality of fluorescent materials 21 placed at a light condensing position 23 may emit light.

As illustrated in FIG. 4C, when the intensity of the laser beam L is caused to be greater than the threshold value th1, a light emitting point P2 and a light emitting point P3 at which the laser beam L does not converge (decrease in diameter) sufficiently in addition to the light emitting point P1 at which the laser beam L has converged (decreased in diameter) sufficiently out of the light condensing positions 23 can also be drawn.

The intensity control unit 620 according to the present embodiment can cause the fluorescent material 21 at a position apart in the direction of the optical axis AX (the optical axis direction) from a light condensing position 23 to emit light by setting the intensity of the laser beam L at the light condensing position 23 to an intensity in which the fluorescent material 21 at the light condensing position 23 is put in the saturated area.

The fluorescent material 21 may be the second fluorescent material (for example, a multiphoton absorber). In this case, the fluorescent material 21 emits light according to the number of absorbed photons. The intensity control unit 620 can also control a light emitting position of the fluorescent material 21 by controlling the intensity of the laser beam L such that the number of photons absorbed by the fluorescent material 21 is changed.

(Step S60) Referring back to FIG. 2, the phase control unit 640 of the control unit 60 controls the phase of the converged beam L3. As described above, by changing the intensity of the laser beam L at the light condensing position 23 (more accurately, the intensity distribution in a space of the laser beam L), it is possible to control the light emission state of the fluorescent material 21 at the light condensing position 23. The phase control unit 640 can cause only one point in the direction of the optical axis AX (the light emitting point P1) at the light condensing position 23 to emit light or cause a plurality of points in the direction of the optical axis AX (for example, three points) (the light emitting points P1 to P3) to emit light by controlling the phase of the converged beam L3.

In the following description, a case in which one point on the optical axis AX is caused to emit light is referred to as “one-point drawing,” a case in which two points on the optical axis AX are caused to emit light is referred to as “two-point drawing,” and a case in which three points on the optical axis AX are caused to emit light is referred to as “three-point drawing.”

That is, the intensity control unit 620 performs control such that the number of light emitting positions at which the fluorescent material 21 emits light in the direction of the optical axis AX (the optical axis direction) and which are formed according to the periodic distribution given by the modulator 220 is set to at least three types of different numbers.

(Step S70) The control unit 60 controls the light condensing position 23 of the converged beam L3 by controlling the converging lens 231 of the converger 230 and the scan mirror 241 of the scanner 240 (that is, by driving the scanner).

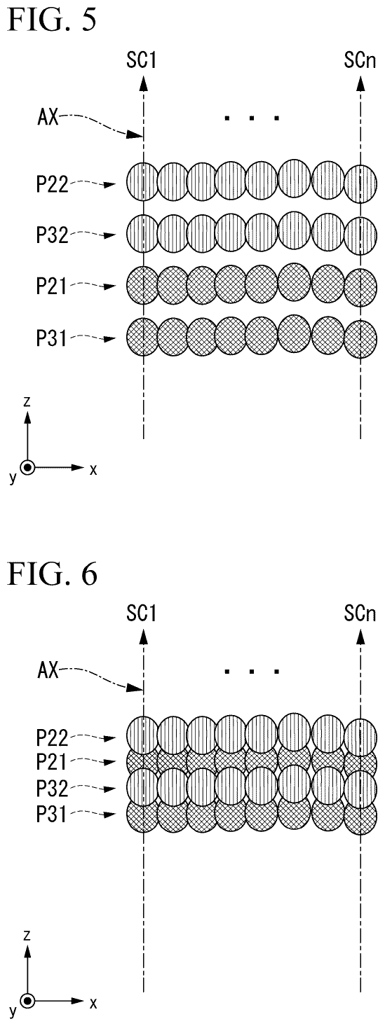

FIG. 5 is a diagram illustrating an example of scanning with a converged beam L3 according to the present embodiment. In this example, the control unit 60 sequentially moves the optical axis AX of the converged beam L3 in the X-axis direction and performs two-point drawing through first irradiation (first scanning SC1) to n-th irradiation (n-th scanning SCn). When two-point drawing is performed at a first light condensing position, a light emitting point P21 and a light emitting point P31 can be caused to emit light. When two-point drawing is performed at a second light condensing position, a light emitting point P22 and a light emitting point P32 can be caused to emit light.

FIG. 6 is a diagram illustrating another example of scanning with a converged beam L3 according to the present embodiment. In this example, the control unit 60 sequentially moves the optical axis AX of the converged beam L3 in the X-axis direction and performs two-point drawing through first irradiation (first scanning SC1) to n-th irradiation (n-th scanning SCn). In the example illustrated in the drawing, a plurality of light condensing positions 23 are closer to each other in the Z-axis direction in comparison with the example illustrated in FIG. 5. When two-point drawing is performed in this state, the light emitting point P21 at the first light condensing position and the light emitting point P22 at the second light condensing position are closer to each other in the Z-axis direction. As a result, the number of light emitting points P per volume (that is, a volume density of the light emitting points P) becomes greater than that in the example illustrated in FIG. 5. In this way, the control unit 60 according to the present embodiment can freely control the number of light emitting points P in the direction of the optical axis AX by controlling the intensity or phase of the laser beam L. With the stereoscopic display device 1 including the control unit 60, it is possible to freely control a drawing state of a stereoscopic image 22 (for example, brightness, contrast, and a spatial resolution of the stereoscopic image 22).

The control unit 60 may realize the aforementioned “one-point drawing,” “two-point drawing,” and “three-point drawing” by combining control of the intensity of the laser beam L (a laser output) and control of the phase in the spatial phase modulator 221. The control unit 60 may select “one-point drawing,” “two-point drawing,” and “three-point drawing” according to the distance D detected by the distance detector 40 or to a combination of the distance D and the illuminance detected by the illuminance detector 50. The control unit 60 performs control on the basis of the distance correction information 310 or the illuminance correction information 320 stored in the storage unit 30 in advance.

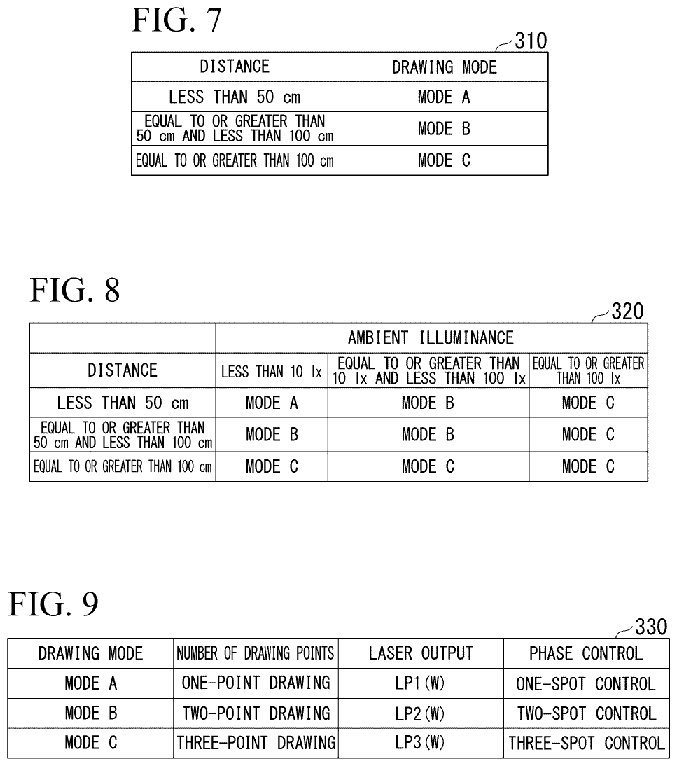

FIG. 7 is a diagram illustrating an example of the distance correction information 310 stored in the storage unit 30 according to the present embodiment. In the example of the distance correction information 310, the control mode “mode A” is correlated with the distance D “less than 50 cm,” the control mode “mode B” is correlated with the distance D “equal to or greater than 50 cm and less than 100 cm,” and the control mode “mode C” is correlated with the distance D “equal to or greater than 100 cm.”

FIG. 8 is a diagram illustrating an example of the illuminance correction information 320 stored in the storage unit 30 according to the present embodiment. In the example of the illuminance correction information 320, one control of “mode A,” “mode B,” and “mode C” is correlated according to a combination of the distance D and the ambient illuminance (brightness).

The control unit 60 selects the control mode with reference to a combination of the distance D detected by the distance detector 40 and the distance correction information 310. Alternatively, the control unit 60 selects the control mode with reference to a combination of the distance D detected by the distance detector 40, the ambient illuminance (brightness) of the drawing space 2 detected by the illuminance detector 50, and the illuminance correction information 320.

FIG. 9 is a diagram illustrating an example of a control table 330 stored in the storage unit 30 according to the present embodiment. In the control table 330, the control modes (for example, mode A, mode B, and mode C) are correlated with the intensities of the laser beam L (the laser output) and phase control states in the spatial phase modulator 221 (for example, one-spot control, two-spot control, and three-spot control).

The control unit 60 controls the laser light source 110 or the spatial phase modulator 221 on the basis of the intensities (laser outputs) of the laser beam L and the phase control states in the spatial phase modulator 221 corresponding to the control modes with reference to the control table 330.

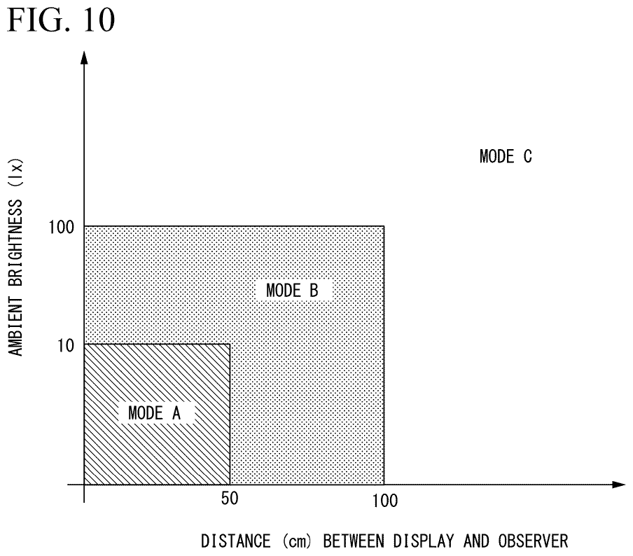

FIG. 10 is a diagram illustrating an example of the control modes in the control unit 60 according to the present embodiment. The control unit 60 selects one of mode A, mode B, and mode C according to a combination of the distance D between the drawing space 2 (that is, the display) and the observer 400 and the ambient illuminance (brightness) of the drawing space 2 and controls the number of light emitting positions (that is, an emission count) of the fluorescent material 21 on the optical axis AX.

That is, the intensity control unit 620 controls the intensity by setting the number of light emitting positions at which the fluorescent material 21 emits light in the direction of the optical axis AX (that is, the optical axis direction) to at least three types of different numbers.

For example, the stereoscopic display device 1 draws a stereoscopic image 22 using “one-point drawing” when the stereoscopic image is intended to express high image quality with priority to brightness.

For example, the stereoscopic display device 1 draws a stereoscopic image 22 using “two-point drawing” or “three-point drawing” when the stereoscopic image is intended to express brightness with priority to high image quality.

For example, the stereoscopic display device 1 can also perform drawing while exchanging “one-point drawing,” “two-point drawing,” and “three-point drawing” according to a display dimension (size) of the stereoscopic image 22 in the drawing space 2.

As described above, with the stereoscopic display device 1 according to the present embodiment, the number of light emitting positions (that is, an emission count) of the fluorescent material 21 on the optical axis AX is controlled on the basis of the detection result from the distance detector 40 or the illuminance detector 50. That is, with the stereoscopic display device 1 according to the present embodiment, it is possible to control a state of a stereoscopic image according to an observation situation.

While embodiments of the present invention have been described above, the present invention is not limited to the embodiments, and various modifications can be added thereto without departing from the gist of the present invention. The embodiments may be appropriately combined.

### REFERENCE SIGNS LIST

1 Stereoscopic display device
2 Drawing space
10 Light source unit
20 Irradiation unit
21 Fluorescent material
22 Stereoscopic image
23 Light condensing position
30 Storage unit
40 Distance detector
50 Illuminance detector
60 Control unit
110 Laser light source
120 Converter
220 Modulator
230 Converger
240 Scanner
610 Distance correction information acquiring unit
620 Intensity control unit
630 Illuminance correction information acquiring unit
640 Phase control unit

1. A stereoscopic display device comprising:
a laser light source configured to emit a laser beam;
a converter configured to convert the emitted laser beam to a collimated beam with a predetermined diameter;
a scanner configured to three-dimensionally scan a light condensing position of the laser beam by using a drawing space including a fluorescent material which is excited to spontaneously emit light with irradiation with a laser beam as a scan target range and changing a focal distance at which the collimated beam converges and an optical axis direction in which the collimated beam is emitted;
a distance detector configured to detect a distance between an observer who observes the drawing space and the drawing space;
a distance correction information acquiring unit configured to acquire distance correction information from a storage unit in which a correlation between the distance and an intensity of the laser beam is stored as the distance correction information; and
an intensity control unit configured to control an intensity at the light condensing position of the laser beam with which scanning is performed by the scanner on the basis of drawing data indicating a light emission intensity at each position in the drawing space and the distance correction information corresponding to the detected distance.

2. The stereoscopic display device according to claim 1, wherein the intensity control unit sets the number of light emission positions at which the fluorescent material emits light along the optical axis direction to at least three types of different numbers and controls the intensity.

3. The stereoscopic display device according to claim 1, further comprising:
an illuminance detector configured to detect ambient illuminance of the drawing space; and
an illuminance correction information acquiring unit configured to acquire illuminance correction information from a storage unit in which a correlation between the illuminance and the intensity of the laser beam is stored as the illuminance correction information,
wherein the intensity control unit controls the intensity of the laser beam additionally on the basis of the illuminance correction information corresponding to the detected illuminance.

4. The stereoscopic display device according to claim 1, wherein the fluorescent material includes a first area in which a spontaneous light emission intensity changes with respect to a change in intensity of a laser beam that irradiates the fluorescent material and a second area in which the spontaneous light emission intensity changes more loosely than the change of the spontaneous light emission intensity in the first area, and
wherein the intensity control unit causes the fluorescent material at a position apart in the optical axis direction from the light condensing position to emit light by setting the intensity of the laser beam at the light condensing position to an intensity at which the fluorescent material at the light condensing position is put in the second area.

5. The stereoscopic display device according to claim 1, further comprising a modulator configured to give a periodic distribution to the intensity of the laser beam in the optical axis direction from the light condensing position by changing a spatial frequency distribution of the laser beam,
wherein the intensity control unit sets the number of light emission positions at which the fluorescent material emits light in the optical axis direction and which is caused by the periodic distribution given by the modulator to at least three types of different numbers and controls the intensity.

6. A stereoscopic display method comprising:
emitting a laser beam;
converting the emitted laser beam to a collimated beam with a predetermined diameter;
three-dimensionally scanning a light condensing position of the laser beam by using a drawing space including a fluorescent material which is excited to spontaneously emit light with irradiation with a laser beam as a scan target range and changing a focal distance at which the collimated beam converges and an optical axis direction in which the collimated beam is emitted;
detecting a distance between an observer who observes the drawing space and the drawing space;
acquiring distance correction information from a storage unit in which a correlation between the distance and an intensity of the laser beam is stored as the distance correction information; and
controlling an intensity at the light condensing position of the laser beam with which scanning is performed by the scanner on the basis of drawing data indicating a light emission intensity at each position in the drawing space and the distance correction information corresponding to the detected distance.
